(19) United States
(12) Patent Application Publication
(10) Pub. No.: US 2009/0136323 A1
(43) Pub. Date: May 28, 2009

(54) Device for transferring a case from a roll-down apparatus to a handover point

(76) Inventor: Frank Tautz, Rahden (DE)

Correspondence Address: ALIX YALE & RISTAS LLP, 750 MAIN STREET, SUITE 1400, HARTFORD, CT, 06103, US

(21) Appl. No.: 12/313,088

(22) Filed: Nov. 17, 2008

(30) Foreign Application Priority Data
Nov. 28, 2007 (DE) 10 2007 057 228.1

(51) Int. Cl. B42C 11/04; B42D 3/00; B42C 7/00

(52) U.S. Cl. 412/21; 412/19; 270/52.18

(57) ABSTRACT

A device (19) for transferring a case (1, 1.1, 1.2) that is assembled from pasteboard and/or cardboard (3) and a cloth (2) from a roll-down apparatus (16) that is composed of a cloth cylinder (11) and at least one pressing roller (15) and interconnects the glued cloth (2) and the blanks (3) to a handover point (31), from which the case (2) can be fed in a cyclic fashion to a turn-in and pressing device (30) for turning in protruding edges of the cloth. The device has a transport element (20) that can be moved forward and backward and non-positively takes hold of the case (1, 1.1, 1.2) exiting the roll-down apparatus (16) during an essentially synchronous movement. The device (19) features a drive unit (22, 23, 23a) that can be acted upon with a control profile (50.1, 50.2) that is variable in dependence on the format height referred to the transport direction, wherein a defined end position (21a) of the transport element (20) at the handover point (31) and a changing transport stroke are realized.

### BACKGROUND

The present invention pertains to a device for transferring a case that is assembled from pasteboard and/or cardboard blanks and a cloth from a roll-down apparatus that is composed of a cloth cylinder and at least one pressing roller and interconnects the glued cloth and the blanks to a handover point, from which the case can be fed in a cyclic fashion to a turn-in and pressing device for turning in protruding edges of the cloth, wherein said device features a transport element that can be moved forward and backward and non-positively takes hold of the case exiting the roll-down apparatus during an essentially synchronous movement.

Transfer devices of this type are used in case-making machines with horizontal processing principle, in which continuously supplied cover boards and a spine insert are joined in a precisely fined fashion with the cloth that features glue applied to the corresponding locations in a roll-down apparatus [Dieter Liebau, Inés Heinze/Industrielle Buchbinderei/Verlag Beruf+Schule/2001/p. 440 ff.]. The protruding edges of the case are turned in while it passes through successively arranged work stations, either in the throughfeed mode or at a standstill, i.e., in an intermittent throughfeed mode of the case.

In case-making machines with intermittent throughfeed through the turn-in stations (see DE 100 57 602 A1), the transfer of the case is realized in such a way that the transport element initially synchronizes to the exiting velocity of the case that is defined by the roll-down apparatus in order to subsequently move with the case in the form of a synchronous motion while taking hold of the case by means of suction cups and, after the case has completely exited the roll-down apparatus, transporting the case to a transfer point arranged upstream of the first turn-in station, e.g., thereabove. After the transfer of the case to the transport system of the turn-in and pressing device, the transport element returns into its starting position with a return motion.

In order to reliably take hold of, in particular, cases with a small format height in the transport direction, the synchronous motion needs to be realized at the shortest distance possible from the roll-down apparatus. On the other hand, the relatively slow synchronous motion needs to be maintained as long as a case with great format height is still clamped between the cloth cylinder and the pressing roller. In the conventional format height range to be processed in case-making machines, this results in a minimum cycle time for the transport element that no longer makes it possible to increase the cycle capacity of the case-making machine, not even if maximum permissible positive and negative accelerations and extremely short transfer times are realized. On the other hand, a format expansion would reduce the maximum cycle capacity for all case formats. Due to the significant stresses caused by high accelerations and speeds, the mechanical elements of the multi-section cam gears and/or turning and sliding pair linkages are subject to increased wear that leads, in particular, to inaccurate transfers to the turn-in station.

### SUMMARY

The present invention is based on the object of providing a device of the type described above that ensures a flawless transfer of the cases and simultaneously makes it possible to increase the capacity of and/or expand the formats processed in the case-making machines.

The device comprises a drive unit that can be acted upon with a control profile that is variable in dependence on the format height referred to the transport direction, wherein a defined end position of the transport element at the handover point and a changing transport stroke are realized such that the required cycle time for the actual forward and backward motion of the transport element can be significantly reduced. The respective control profile may be (time-) optimized referred to the corresponding format height of the case. The extreme transport conditions occurring while processing small and large formats no longer need to be taken into account simultaneously in the motion profile of the transport element and in the control profile of the drive unit. The cycle time saved can be used for extending the transfer time at the handover point, for expanding the formats processed and/or for increasing the cycle capacity, wherein maximum permissible accelerations are reliably observed such that the transfer device is only subjected to little wear during its operation and a flawless transfer of the cases is promoted.

The transport stroke is preferably reduced as the format height increases. For example, a maximum transport stroke is provided for cases with a small format height in order to receive the respective case directly downstream of the roll-down apparatus, wherein the transport stroke is reduced at greater format heights in such a way that the case practically is not taken hold of until immediately before it completely exits the roll-down apparatus.

One advantageous and therefore preferred additional development may be characterized in that the respective control profiles have identical first and second motion segments for synchronizing the motion or realizing a synchronized motion between the transport element and the case exiting the roll-down apparatus.

A third motion segment of variable stroke may be realized such that the shortest transport time possible is achieved and pre-definable maximum positive and negative accelerations can be observed. For example, the transport element can be accelerated beyond the synchronous speed defined by the roll-down apparatus, particularly after a case with a small format height has completely exited the apparatus, in order to significantly shorten the transport time for the maximum transport stroke required for the small format.

One advantageous and therefore preferred additional development may be characterized in that at least two different control profiles are prepared for the drive unit and respectively assigned to a certain format height range. The control profile only needs to be exchanged when the format limits are exceeded. The specification of the respective control profile is advantageously realized by connecting the drive unit to a control unit. The respective control profile can be automatically specified in order to act upon the drive unit based on the format height stored in this control unit.

Another advantageous and therefore preferred additional development may be characterized in that the drive unit features a drive that is realized separately of the roll-down apparatus and the first turn-in station arranged downstream thereof. The drive unit preferably comprises a servomotor and at least one spindle, toothed belt, chain or similar driving means that engages on the displaceably guided transport element or the transport element is arranged directly on the output element of a linear servomotor. In addition to a simple change of the control profile, the separate drive also provides new options in the handling of defects in the case-making machine. For example, a defectively joined case may be retained by the transport element at an easily accessible removal point while the turn-in station and/or the roll-down apparatus are controlled into a different phase position in order to repair their defect.

### BRIEF DESCRIPTION OF THE DRAWING

Aspects of the present invention are elucidated in the following description of one preferred embodiment that refers to the accompanying drawing, in which:

FIG. 1 shows a detail of a case-making machine in the form of a schematic side view;

FIG. 2a shows the transfer of a small-format case in the form of a schematic representation;

FIG. 2b shows the transfer of a large-format case;

FIG. 3a shows a motion diagram of the transfer device that is designed for the transfer of a small-format case; and

FIG. 3b shows a motion diagram that is designed for the transfer of a large-format case.

### DETAILED DESCRIPTION

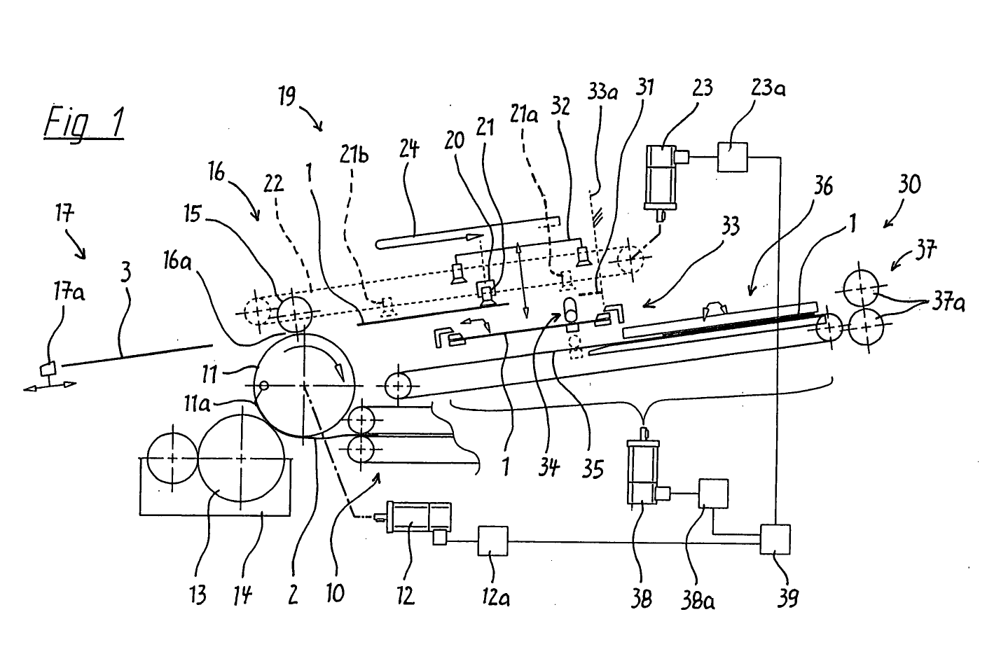

FIG. 1 shows a detail of a case-making machine for a printed book or the like, in which continuously supplied blanks of cover boards and a spine insert (referred to as cardboards 3 below) are joined in a precisely fitted fashion with a cloth 2 that features glue applied to the corresponding locations in a roll-down apparatus 16 such that a case 1 is produced. The protruding edges of the case 1 are turned in and pressed down in successively arranged work stations 33, 36 of a turn-in and pressing device 30 during its subsequent intermittent transport.

The cloth 2 is transferred by means of a cloth feed 10 to a continuously rotating cloth cylinder 11 that takes hold of the cloth 2 with grippers 11a, guides the cloth past the glue application roller 13 of a gluing station 14 and subsequently releases the cloth once again in the roll-down point 16a of the roll-down apparatus 16. The cardboards 3 are fed to the roll-down point 16a synchronous with the cloth 2 by means of cardboard pushers 17a of a cardboard feed 17 that carry out a forward and backward motion. Pressing rollers that act upon the cardboards 3 in the roll-down point 16a ensure that the cloth 2 is rolled down on the cardboards 3 without bubbles.

The case 1 exiting the roll-down apparatus 16 is transferred to a handover point 31 arranged upstream of the turn-in stations 33, 36 by means of the inventive transfer device 19, wherein the front edge of the case 1 is transported against a reference edge 33a of fixed format, i.e., a reference edge that is identical for all formats. The transfer device 19 features a guided transport element in the form of a suction beam 20 that is equipped with a plurality of adjacently arranged suction cups 21 and can be moved forward and backward between the roll-down apparatus 16 and the handover point 31 by means of a toothed belt 22. The suction beam 20 already takes hold of the case 1 while it is still continuously advanced by the cloth cylinder 11 and the pressing rollers 15.

The reciprocating forward and backward motion 24 of the suction beam 20 or its suction cups 21, respectively, is indicated in FIG. 1 with a motion arrow 24 that represents the transport stroke. The suction cups 21a and 21b illustrated with broken lines indicate the front end position of the suction cup 21a and the rear end position of the suction cup 21b. A defined front suction cup end position 21a is realized due to the fixed-format reference edge 33a, against which each case 1 is transported with its front edge.

From the handover point 31, the case 1 is transferred into the head/foot turn-in station 33 that lies at a lower elevation by means of a suction-type ram 32, wherein the case 1 can be deposited on a conveyor belt 35 by means of a clamping and lifting element 34 after the edges protruding at the head and the foot were turned in and pressed down in order to transfer the case into the lateral turn-in station 36 for turning in and pressing down the laterally protruding edges. Subsequently, the case 1 is transferred to continuously driven pressing rollers 37a of a pressing station 37 in order to carry out the full-surface pressing of the cloth 2 against the cardboards 3.

According to the disclosure, the transfer device 19 comprises a drive unit (22, 23, 23a) that can be acted upon with a control profile that is variable in dependence on the format height referred to the transport direction. This is advantageously achieved with a drive 23 that is realized separately of the drive 12 of the roll-down apparatus 16 and the drive 38 of the turn-in and pressing device 30. The functionality could also be realized in the form of a mechanical drive coupling with one of the aforementioned functional units. Different control profiles could be made available by utilizing different radial cams of a corresponding intermediate gear that transmits irregularly, wherein a corresponding mechanical change-over is also required in this case.

The present embodiment, however, features a servomotor 23 for the transfer device 19 because it also provides advantages other than a very simple change of the control profile which can be used, e.g., for the user-friendly handling of defects in the case-making machine. For example, a defectively joined case 1 can be retained by the suction beam 20 at an easily accessible removal point while the head/foot turn-in station 33 and/or the roll-down apparatus 16 are controlled into a different phase position in order to repair their defect. In addition, the other characteristics disclosed in the dependent claims can be realized most conveniently with servo technology.

In the present case-making machine, at least one servomotor 12 is provided for the cloth cylinder, one servomotor 38 is provided for the turn-in and pressing device 30 and the aforementioned servomotor 23 is provided for the transfer device 19. The respectively assigned controllers 12a, 38a and 23a are connected to a master control unit 39, in which a virtual master is created that is followed by the respective drives 12, 38 and 23. The respective control profile also is automatically specified in this control unit 39 in accordance with the respective format height of the case 1 to be processed and forwarded to the servo drive (servomotor 23 with controller 23a).

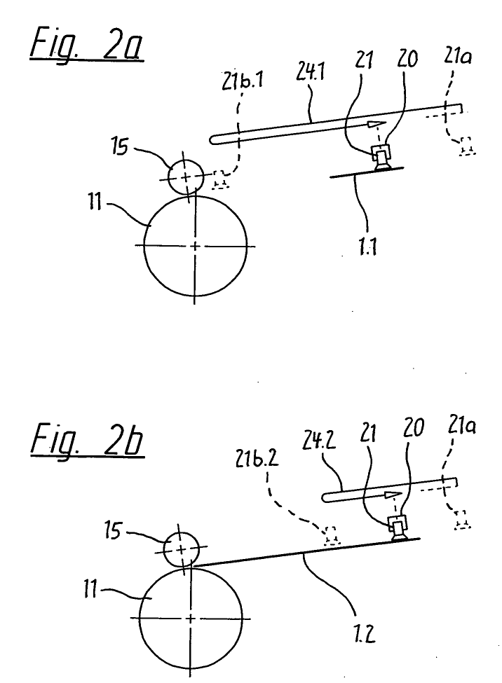

FIGS. 2a and 2b show the lifting motions 24.1 and 24.2 of the suction beam 20 that are respectively used for transferring a case 1.1 of the smallest format and a case 1.2 of the largest format. One can recognize that the front end position 21a of the suction device is respectively identical that in FIG. 1, in which the lifting motion 24 is illustrated for an intermediate format. However, the rear end positions 21b.1, 21b.2 and 21b of the suction device are positioned differently in this case. The rear end position 21b.1 of the suction device lies near the exit region from the roll-down apparatus 16 when processing a case 1.1 of the smallest format while the rear end position 21b.2 is spaced apart therefrom by a greater distance when processing a case 1.2 of the largest format. The transport stroke consequently decreases as the format height increases.

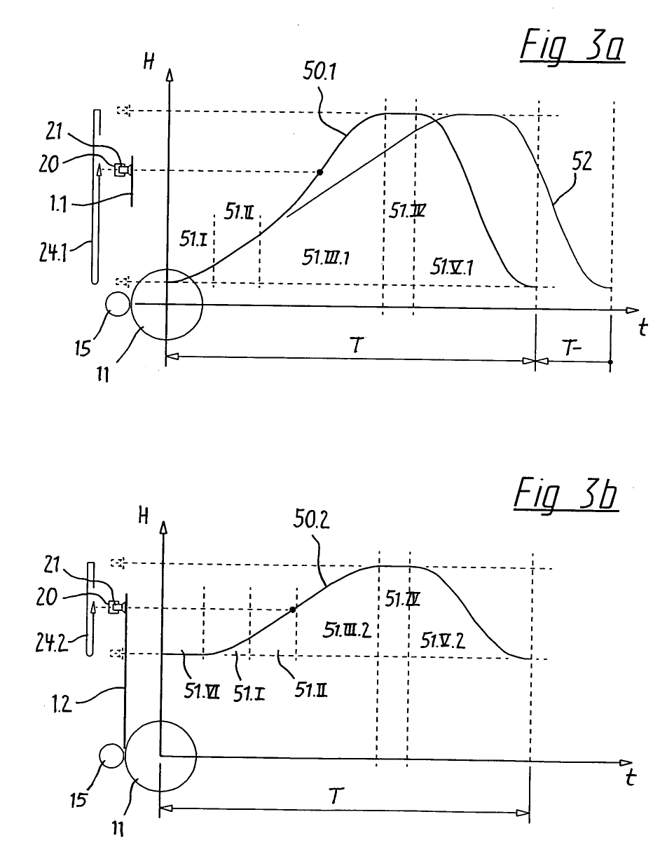

In the motion diagrams according to FIGS. 3a and 3b, the motion curves 50.1, 50.2 are respectively illustrated in the form of control profiles for the smallest and the largest format. The time t is plotted on the x-axis and the stroke H is plotted on the y-axis. Both motion curves feature identical first and identical second motion segments 51.I, 51.II. In the first motion segment 51.I, the suction beam 20 accelerates from a dwell 51.VI or a motion reversal to the exiting velocity of the case 1 from the roll-down apparatus 16. After this synchronization, the second motion sequence 51.II is carried out, in which the suction beam 20 moves synchronous with the exiting case 1 and the pneumatically controlled suction cups 21 can take hold of the case in a reliable and accurately positioned fashion.

Subsequently, a third motion sequence 51.III.1 or 51.III.2 is carried out that differs significantly with respect to stroke and time for the smallest 1.1 and the largest 1.2 format of the case. When processing the largest format 1.2, the synchronous motion of the suction beam 20 is initially maintained over a certain distance (because a rear section of the case 1.2 may still be situated in the roll-down apparatus 16) and then decelerated during the transition to the dwell 51.IV, in which the case 1.2 can be transferred to the suction-type ram 32.

When processing the smallest format 1.1, the suction beam is initially accelerated beyond the synchronous speed after the case 1.1 has completely exited the roll-down apparatus 16 and then also decelerated during the transition to the dwell 51.IV. After the transfer of the case 1, 1.1, 1.2 to the suction-type ram 32 or at the end of the dwell 51.IV, the suction beam 20 returns into its above-described starting position with a return motion 51.V.I or 51.V.II, respectively.

FIG. 3a shows a motion curve 52 according to the state of the art, by means of which the smallest format 1.1 and the largest format 1.2 were transferred from the roll-down apparatus 16 to the handover point 31. Since the transfer device 19 is acted upon, according to the invention, with different control profiles or motion curves 50.1, 50.2 in dependence on the format height, it was possible to shorten the cycle time T by the time difference T—such that it is possible to significantly increase the capacity by more than 20%.

The respectively applied control profiles or motion curves can be calculated in the control 39 based on the format height in accordance with a stored formula. Alternatively, the different control profiles or motion curves may also be stored in the control in the form of data sets that are assigned to the respective format heights. It was determined that only two different control profiles or motion curves such as, e.g., the two motion curves 50.1 in 50.2 already result in a significant reduction of the cycle time T. In this case, the two motion curves 50.1 and 50.2 respectively apply to a format height range that may, if applicable, overlap with another format height range. The other motion curve is only selected in order to act upon the servo drive (23, 23a) when the range limits are exceeded.

1. A device (19) for transferring a case (1, 1.1, 1.2) having a format height that is assembled from cover board blanks (3) glued to a cloth (2) at a roll down point on a roll-down apparatus (16) that is composed of a cloth cylinder (11), a glue applicator and at least one pressing roller (15) and interconnects the case to a handover point (31), from which the case (2) is fed in a cyclic fashion to a turn-in and pressing device (30) for turning in protruding edges of the cloth, wherein said device includes a transport element (20) movable forward and backward over a transport stroke and non-positively takes hold of the case (1, 1.1, 1.2) exiting the roll-down apparatus (16) during synchronous speed movement, wherein the improvement comprise that the device (19) includes a transport element drive unit (22, 23, 23a) responsive to a control profile (50.1, 50.2) that is variable in dependence on the format height referred to the transport direction, producing a uniform end position (21a) of the transport element (20) at the handover point (31), and a changing transport stroke commensurate with said format height.

2. The device according to claim 1, wherein the transport stroke is correspondingly reduced as the format height increases.

3. The device according to claim 1, wherein all the control profiles (50.1, 50.2) produce a plurality of motion segments which have substantially identical first and substantially identical second motion segments (51.I and 51.II) for the synchronization of the transport element (20) with the case (1, 1.1, 1.2) exiting the roll-down apparatus (16).

4. The device according to claim 3, wherein each control profile produces a third motion segment (51.III.1, 51.III.2) of variable stroke by which the shortest transport time possible is achieved while still observing pre-definable positive and negative maximum accelerations.

5. The device according to claim 1, wherein the transport element (20) can be accelerated beyond the synchronous speed defined by the roll-down apparatus (16) after the respective case (1, 1.1, 1.2) has completely exited the roll-down apparatus (16).

6. The device according to claim 1, wherein at least two different control profiles (50.1, 50.2) are assigned to a certain format height range.

7. The device according to claim 1, wherein the control profile (50.1, 50.2) is specified by a connection of the drive unit (22, 23, 23a) to a control unit (39).

8. The device according to claim 1, wherein the drive unit comprises a drive that is separate from the roll-down apparatus (16) and the first turn-in station (33) arranged downstream thereof.

9. The device according to claim 8, wherein the drive unit (22, 23, 23a) comprises a servomotor (23) and at least one of a spindle, toothed belt (22), or chain that engages the transport element (20) which transport element is displaceably guided.

10. The device according to claim 8, wherein the transport element (20) is arranged on an output element of a linear servomotor.

11. The device according to claim 2, wherein all the control profiles (50.1, 50.2) produce a plurality of motion segments which have substantially identical first and substantially identical second motion segments (51.I and 51.II) for the synchronization of the transport element (20) with the case (1, 1.1, 1.2) exiting the roll-down apparatus (16).

12. The device according to claim 11, wherein each control profile produces a third motion segment (51.III.1, 51.III.2) of variable stroke by which the shortest transport time possible is achieved while still observing pre-definable positive and negative maximum accelerations.

13. The device according to claim 2, wherein the transport element (20) can be accelerated beyond the synchronous speed defined by the roll-down apparatus (16) after the respective case (1, 1.1, 1.2) has completely exited the roll-down apparatus (16).

14. The device according to claim 11, wherein the transport element (20) can be accelerated beyond the synchronous speed defined by the roll-down apparatus (16) after the respective case (1, 1.1, 1.2) has completely exited the roll-down apparatus (16).

15. The device according to claim 2, wherein at least two different control profiles (50.1, 50.2) are assigned to a certain format height range.

16. The device according to claim 11, wherein at least two different control profiles (50.1, 50.2) are assigned to a certain format height range.

17. The device according to claim 11, wherein the drive unit comprises a drive that is separate from the roll-down apparatus (16) and the first turn-in station (33) arranged downstream thereof.

18. The device according to claim 12, wherein the transport element (20) can be accelerated beyond the synchronous speed defined by the roll-down apparatus (16) after the respective case (1, 1.1, 1.2) has completely exited the roll-down apparatus (16).

19. The device according to claim 12, wherein at least two different control profiles (50.1, 50.2) are assigned to a certain format height range.

20. The device according to claim 12, wherein the control profile (50.1, 50.2) is specified by a connection of the drive unit (22, 23, 23a) to a control unit (39) and the drive unit comprises a drive that is separate from the roll-down apparatus (16) and the first turn-in station (33) arranged downstream thereof.
